(19) United States
(12) Patent Application Publication
(10) Pub. No.: US 2009/0228580 A1
(43) Pub. Date: Sep. 10, 2009

(54) COMPUTING ENVIRONMENT SENSITIVE DATA SYNCHRONIZATION

(75) Inventor: Joseph Celi, JR., Boca Raton, FL (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/042,570

(22) Filed: Mar. 5, 2008

(51) Int. Cl. G06F 15/16

(52) U.S. Cl. 709/224

(57) ABSTRACT

Embodiments of the present invention provide a method and computer program product for computing environment sensitive data synchronization in a pervasive device. In an embodiment of the invention, a method for computing environment sensitive data synchronization in a pervasive device can be provided. The method can include monitoring environmental conditions in the pervasive device, batching data for synchronization in the pervasive device with a communicatively coupled server, and initializing the synchronization of the batched data with the coupled server only when the environmental conditions indicate either an idle condition in the pervasive device or an activity break in activity in the pervasive device.

### BACKGROUND OF THE INVENTION

1. Field of the Invention

The present invention relates to the field of pervasive computing and more particularly to data synchronization for pervasive computing devices.

2. Description of the Related Art

Personal computers no longer are the most common vehicle through which users connect to data communications networks like the Internet. Now that computing can be viewed as being truly everywhere, computer scientists and information technologists have begun to rethink those services that can be provided to meet the needs of mobile computing users. In consequence, the study of pervasive computing has resulted in substantial innovation in the field of network connectivity. “Pervasive computing” has been defined as referring to any non-constrained computing device not physically tethered to a data communications network. Thus, pervasive computing devices refer not only to computers wirelessly linked to networks, but also to handheld computing devices, wearable systems, embedded computing systems and the like.

Most pervasive devices, including notebook computers, handheld computers and even data enabled cellular telephones permit data synchronization with a different computing device, for example a desktop computer. Data synchronization refers to the harmonization of data between two data sources such that the data contained in each data source can be reconciled notwithstanding changes to the data applied in either or both of the data sources. Modern pervasive devices provide for a synchronization process through a direct cable link, a modem link, or a network link to a host computing device. Wireless pervasive devices further can accommodate synchronization over infrared or radio frequency links.

Excessive and unnecessary consumption of computing resources arises in the context of filtered synchronization. In filtered synchronization, updates can be filtered according to specified filtering criteria. As a result, only a subset of available updates will be pushed to the pervasive device. Filtered synchronization can occur at the manual behest of an end user, or dynamically as changes are detected in the pervasive device. In the latter circumstance, an event can be triggered whenever a change is detected resulting in a synchronization. Recognizing that events can occur in groupings within a short period of time, it is common to wait in response to an event for a period of time in order to provide for batched synchronization of several changes at once.

Once a batch of changes have been queued for synchronization, a background process can execute in which the filtered synchronization can be performed while foreground applications continue to function. Yet, it is to be recognized that a data synchronization can be resource intensive and can degrade or outright impede the performance of the pervasive device. Further, to the extent that resources within the pervasive device fall below a critical level of availability—for instance, battery life, central processing unit (CPU) cycles, communications bandwidth or memory—a data synchronization can prevent foreground tasks in the pervasive device or indeed the pervasive device itself from functioning.

### BRIEF SUMMARY OF THE INVENTION

Embodiments of the present invention address deficiencies of the art in respect to data synchronization in a pervasive device, and provide a novel and non-obvious method and computer program product for computing environment sensitive data synchronization in a pervasive device. In an embodiment of the invention, a method for computing environment sensitive data synchronization in a pervasive device can be provided. The method can include monitoring environmental conditions in the pervasive device, batching data for synchronization in the pervasive device with a communicatively coupled server, and initializing the synchronization of the batched data with the coupled server only when the environmental conditions indicate either an idle condition in the pervasive device or an activity break in activity in the pervasive device.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for computing environment sensitive data synchronization for pervasive devices;

FIG. 2 is a schematic illustration of a pervasive device configured for computing environment sensitive data synchronization; and,

FIG. 3 is a flow chart illustrating a process for computing environment sensitive data synchronization in a pervasive device.

### DETAILED DESCRIPTION OF THE INVENTION

Embodiments of the present invention provide a method, system and computer program product for computing environment sensitive data synchronization for pervasive devices. In accordance with an embodiment of the present invention, data synchronization in the pervasive device can be delayed until monitored environmental conditions permit data synchronization with minimal opportunity to impede the operation of the pervasive device. Specifically, the computing environment for the pervasive device, for example battery life, CPU use, network use, and application activity can be monitored. Data synchronization can occur during a detected idle condition, or when an activity break in application usage is detected. Otherwise, data synchronization can be delayed until an activity break or idle condition.

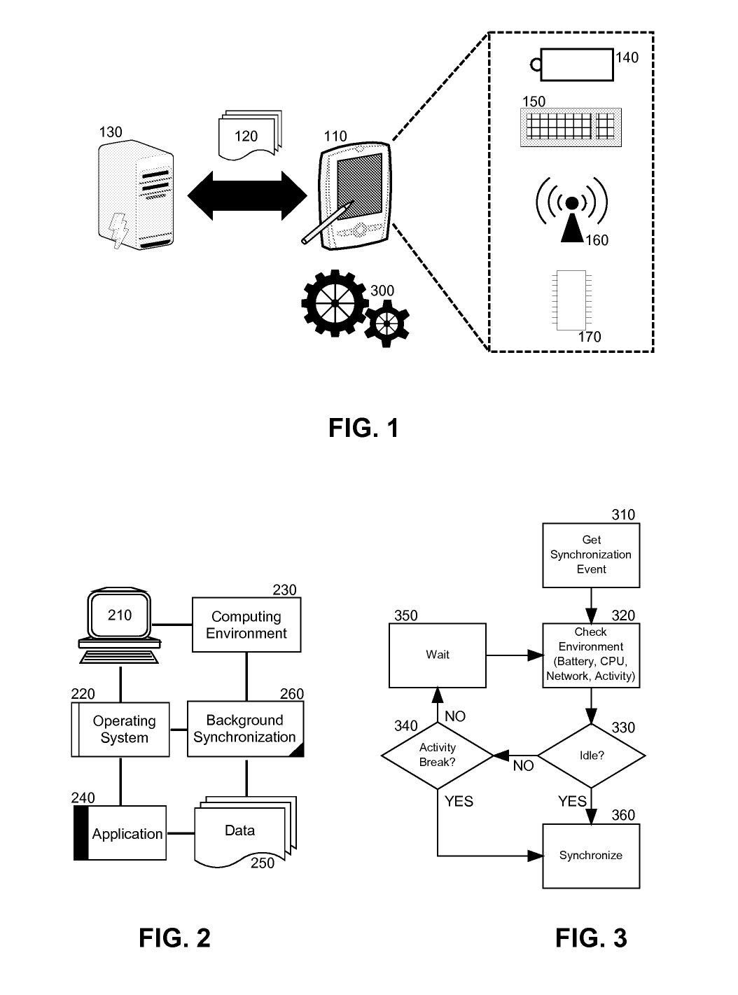

In further illustration, FIG. 1 is pictorially depicts a process for computing environment sensitive data synchronization for pervasive devices. As shown in FIG. 1, a pervasive device 110 can be configured for data synchronization 120 with a server 130 such that data in the pervasive device 110 can be synchronized with corresponding data in the server 130. Before engaging in data synchronization 120, however, a background dispatcher 300 can monitor computing conditions for the pervasive device 110 to determine whether or not the data synchronization 120 is likely to interfere with the operation of one or more applications in the pervasive device 110.

For example, the remaining battery life 140 of the pervasive device 110 can be monitored. Further, keyboard and other input method interactions 150 with the pervasive device 110 (including keyboard strokes and screen taps) can be monitored. Yet further, network activity 160 for the pervasive device 110 can be monitored. Finally, CPU activity 170 for the pervasive device 110 can be monitored. In consequence, the data synchronization 120 can be permitted subject to adequate battery life 140 so as to avoid unnecessarily draining the battery life 150. Further, data synchronization 120 can be permitted when network activity 160 is subdued to provide ample bandwidth for co-executing applications in the pervasive device 110. Yet further, data synchronization 120 can be permitted during periods of detected inactivity, such as when CPU activity 170 is low, or when input method interactions 150 have not been detected for a threshold period of time.

In further illustration, FIG. 2 schematically shows a pervasive device configured for computing environment sensitive data synchronization. The pervasive device can include a computing host 210 providing a computing environment 230 and supporting the execution of an operating system 220. The operating system 220 in turn can provide a host computing environment for one or more executing applications 240 (only a single application 240 shown for the purpose of illustrative simplicity). An application 240 executing through the operating system 220 can manipulate data 250 to be synchronized with data in a coupled server (not shown).

Notably, background synchronization logic 260 can be provided to manage the synchronization of the data 250 with the coupled server (not shown). The background synchronization logic 260 can be configured to perform the synchronization of the data 250 as a background process in the computing host 210. Further the background synchronization logic 260 can be configured to perform the synchronization of the data 250 in batched form. Even yet further, the background synchronization logic 260 can be configured to schedule the batched synchronization of the data 250 when the computing environment 230 shows an idle condition in the computing host 210, or an activity break in usage of the application 240.

In further illustration of the operation of the background synchronization logic 260, FIG. 3 is a flow chart illustrating a process for computing environment sensitive data synchronization in a pervasive device. Beginning in block 310, a synchronization event can be received indicating a change in data requiring synchronization. In block 320, the computing environment, for example battery life, CPU use, network use, and application activity, can be monitored. In decision block 330, if it is determined that the pervasive device is idle, for instance by reference to low CPU activity or no applications loaded, power hibernation, in block 360 synchronization of the data can commence.

Otherwise, in decision block 340, if it is determined that the pervasive device is not idle, it further can be determined whether or not a break has occurred in the activity for an application. For example, the switching into the foreground of a new application can be indicative of an activity break, or the bringing into focus of a new application can be indicative of an activity break, or an application termination of the application can indicate an activity break. If an activity break is determined, in block 360, synchronization of the data can commence. Otherwise, in block 350 the data synchronization can wait until the environmental conditions indicate either idleness of the pervasive device or an activity break in applications in the pervasive device.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for computing environment sensitive data synchronization in a pervasive device, the method comprising:
monitoring environmental conditions in the pervasive device;
batching data for synchronization in the pervasive device with a communicatively coupled server; and,
initializing the synchronization of the batched data with the coupled server only when the environmental conditions indicate either an idle condition in the pervasive device or an activity break in activity in the pervasive device.

2. The method of claim 1, further comprising delaying the synchronization if battery conditions monitored in the pervasive device is low.

3. The method of claim 1, further comprising delaying the synchronization if network bandwidth monitored in the pervasive device is low.

4. The method of claim 1, further comprising delaying the synchronization if input method interactions monitored in the pervasive device are detected.

5. The method of claim 1, wherein monitoring environmental conditions in the pervasive device, comprises monitoring environmental conditions in the pervasive device to identify an activity break in an application in the pervasive device through a detection of a termination of the application.

6. The method of claim 1, wherein monitoring environmental conditions in the pervasive device, comprises monitoring environmental conditions in the pervasive device to identify an activity break in an application in the pervasive device through a detection of an activation of a different application in the pervasive device.

7. The method of claim 1, wherein monitoring environmental conditions in the pervasive device, comprises monitoring environmental conditions in the pervasive device to identify an activity break in an application in the pervasive device through a detection of a change in focus from one application to another in the pervasive device.

8. A computer program product comprising a computer usable medium embodying computer usable program code for computing environment sensitive data synchronization in a pervasive device, the computer program product comprising:
computer usable program code for monitoring environmental conditions in the pervasive device;
computer usable program code for batching data for synchronization in the pervasive device with a communicatively coupled server; and,
computer usable program code for initializing the synchronization of the batched data with the coupled server only when the environmental conditions indicate either an idle condition in the pervasive device or an activity break in activity in the pervasive device.

9. The computer program product of claim 8, further comprising computer usable program code for delaying the synchronization if battery conditions monitored in the pervasive device is low.

10. The computer program product of claim 8, further comprising computer usable program code for delaying the synchronization if network bandwidth monitored in the pervasive device is low.

11. The computer program product of claim 8, further comprising computer usable program code for delaying the synchronization if input method interactions monitored in the pervasive device are detected.

12. The computer program product of claim 8, wherein the computer usable program code for monitoring environmental conditions in the pervasive device, comprises computer usable program code for monitoring environmental conditions in the pervasive device to identify an activity break in an application in the pervasive device through a detection of a termination of the application.

13. The computer program product of claim 8, wherein the computer usable program code for monitoring environmental conditions in the pervasive device, comprises computer usable program code for monitoring environmental conditions in the pervasive device to identify an activity break in an application in the pervasive device through a detection of an activation of a different application in the pervasive device.

14. The computer program product of claim 8, wherein the computer usable program code for monitoring environmental conditions in the pervasive device, comprises computer usable program code for monitoring environmental conditions in the pervasive device to identify an activity break in an application in the pervasive device through a detection of a change in focus from one application to another in the pervasive device.
